(19) United States
(12) Patent Application Publication
(10) Pub. No.: US 2009/0116696 A1
(43) Pub. Date: May 7, 2009

(54) SYSTEM, METHOD AND MACHINE-READABLE MEDIUM FOR CHARACTERIZING NANOTUBE MATERIALS

(76) Inventors: Steffen McKernan, San Clemente, CA (US); Dawei Wang, Irvine, CA (US); Zhen Yu, Irvine, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/126,821

(22) Filed: May 23, 2008

Related U.S. Application Data
(60) Provisional application No. 60/940,616, filed on May 29, 2007.

(51) Int. Cl. G06K 9/00

(52) U.S. Cl. 382/108; 382/100

(57) ABSTRACT

A computer implemented method of characterizing a nanotube material by sampling a region of the nanotube material using a scanning electron microscope (SEM) to obtain at least one image, and analyzing the at least one image using an image processing algorithm to characterize the nanotube material.

### RELATED APPLICATION

This application claims the benefit of and priority to U.S. Provisional Application Ser. No. 60/940,616, filed May 29, 2007, the contents of which are incorporated by reference herein in its entirety.

### BACKGROUND

This disclosure relates generally to the characterization of nanotube materials and, more particularly, to a method for accurately and consistently characterizing nanotube materials.

### SUMMARY

According to one or more embodiments, a computer implemented method and machine readable medium are provided for characterizing a nanotube material using an automatic focus feature of a scanning electron microscope (SEM) to image a region of the nanotube material and analyze the image using an image processing algorithm to characterize the nanotube material. In one embodiment, the nanotube material is sampled by aligning a beam from the scanning electron microscope (SEM) above the region of the nanotube material, autofocusing the scanning electron microscope (SEM) on the region of the nanotube material, and capturing at least one image of the region of the nanotube material. The physical characteristics of the nanotube material, such as count, density, length, straightness, alignment and defects, may be determined to predict the performance of the nanotube material.

According to one or more embodiments, an image processing system for characterizing a nanotube material is disclosed. The image processing system may include a memory for storing at least one image of a nanotube material, and a processor configured to retrieve the at least one image from the memory and analyze a characteristic of the nanotube material from the at least one image.

### DRAWINGS

The above-mentioned features and objects of the present disclosure will become more apparent with reference to the following description taken in conjunction with the accompanying drawings wherein like reference numerals denote like elements and in which:

FIG. 1 is an exemplary flow chart representing a method for characterizing nanotube materials, according to one embodiment of the present disclosure.

FIG. 2 illustrates a sample SEM image of a nanotube material using a manual focus technique.

FIG. 3 illustrates an intentionally blurred SEM image.

FIG. 4 illustrates a sample SEM image of a nanotube material using an autofocus technique, according to one embodiment of the present disclosure.

### DETAILED DESCRIPTION

In the description that follows, the present invention will be described in reference to a preferred embodiment for characterizing nanotube materials. The present invention, however, is not limited to any particular application nor is it limited by the examples described herein. Therefore, the description of the embodiments that follow are for purposes of illustration and not limitation.

In one embodiment, the present disclosure may be used to automate the characterization of nanotube materials. An automatic focus function of Scanning Electron Microscopes (SEMs) may be used to capture images of sample regions of the nanotube material in a statistically significant way. Data of sampled regions may then be stored in a memory and analyzed by a processor. In one embodiment, image processing algorithms may be utilized to analyze and score the images obtained.

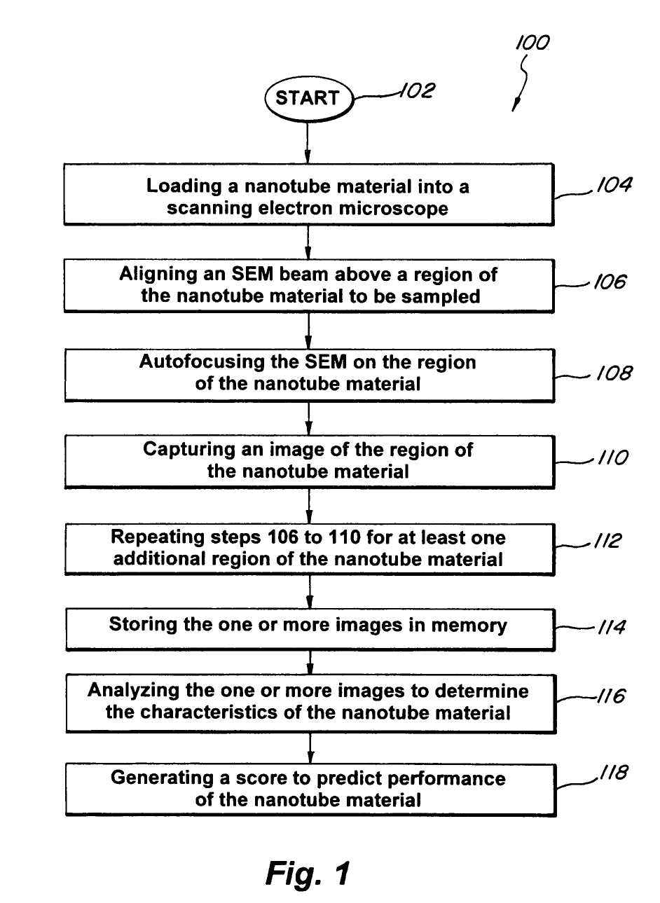

FIG. 1 is an exemplary flow chart 100 representing a method for characterizing nanotube materials, according to one embodiment of the present disclosure. The method begins (102) by loading a nanotube material into a SEM, such as by an operator or by an automated system in a manufacturing process (104). Next, a selected region of the nanotube material may be imaged or sampled using the SEM. An automated test script may be used with the SEM to image a statistically significant portion of the nanotube material.

The automated test script can be implemented using hardware, software or a combination of hardware and software. The automated test script is generally stored in a storage device or in the memory and is executed by a processor. The storage device can be referred to as a machine-readable medium, which may be any mechanism that provides (i.e. stores and/or transmits) information in a form readable by a computer. For example, the machine-readable medium may be a read only memory (ROM), a random access memory (RAM), a cache, a hard disk drive, a floppy disk drive, a magnetic disk storage media, an optical storage media, a flash memory device or any other device capable of storing information.

In one embodiment, the automated test script may provide instructions, which when read by a processor, cause the SEM to perform operations, such as aligning an SEM beam above a region of the nanotube material to be sampled (106), autofocusing the SEM on the region of the nanotube material (108), capturing an image of the region of the nanotube material (110). In one embodiment, steps 106 through 110 are repeated for at least one additional region of the nanotube material (112).

The images may then be recorded in a digital format, such as via batch recording, image by image, or a combination thereof, and stored in memory (114). Next, the images are digitally analyzed using an image processing algorithm described below that analyzes different characteristics of the nanotube material, such as density, length, and alignment (116). Analysis results with a score may be generated and recorded to characterize the nanotube sample. Scores may be tailored to predict the performance of the nanotube material for different applications (118).

As can be envisioned by a person skilled in the art, the regions and images of statistical significance may be determined based on past analysis results or, if the analysis described in image processing algorithm below happens concurrent with the image acquisition, the sampling requirements may be updated in real time based on earlier images taken of the sampled nanotube material. For example, repeated sampling and analysis of at least one additional region may be performed until a certain confidence level is achieved. In one embodiment, the image processing algorithm may be programmed to dynamically adjust for sampling requirements based on real time image analysis. The image processing algorithm may be used to analyze the alignment of the nanotube materials in real time until a certain desired uniformity and confidence level is achieved.

### Image Processing Algorithm

The image processing algorithm can be implemented using hardware, software or a combination of hardware and software, such as an image processing system. The image processing algorithm is generally stored in a storage device or in the memory and is executed by a processor. The storage device can be referred to as a machine-readable medium, which may be any mechanism that provides (i.e. stores and/or transmits) information in a form readable by a computer. For example, the machine-readable medium may be a read only memory (ROM), a random access memory (RAM), a cache, a hard disk drive, a floppy disk drive, a magnetic disk storage media, an optical storage media, a flash memory device or any other device capable of storing information.

For purposes of this description of this embodiment, it will be presumed that the SEM image file data is stored as an array of pixels with M pixels in a ‘horizontal’ row and N ‘vertical’ rows. It is understood that the present method can be applied to other file formats. The size of each pixel may be determined by the SEM settings which may be recorded in the image file or in a separate file. The image processing algorithm may be used to process the image pixels and their ‘neighbors’ to measure physical characteristics such as nanotube length, straightness, alignment, density, crosses, and splits. In one embodiment, the process applies primarily to nanotube materials with some measure of vertical alignment. In other embodiments, the same process may work on ‘horizontally’ or arbitrarily aligned nanotube materials by rotating the image at a certain non-parallel angle (e.g., 90 degrees would be simple but potentially not optimal) and running the same analysis. As is appreciated by a person skilled in the art, performing multiple processes in different directions and combining the results would increase the robustness of the result.

### Count

The image processing algorithm may be used to count the number of nanotube materials in an image by processing pixels across a row searching for differences between adjacent pixels and/or groups of pixels. The presence of a nanotube material may be identified by comparing changes along a pixel row to a predetermined nanotube ‘signature’ or sequence of changes known to be due to a nanotube material. In one embodiment, this nanotube ‘signature’ may be defined by a rapid increase in pixel brightness followed by a decline in pixel brightness as the image processing algorithm analyzes across a ‘length’ as determined by the number of pixels and the magnification. If catalyst islands or other structures are used to grow the nanotube materials, their coordinates can be input or their presence can be determined by a different ‘signature’ which may be defined by larger areas of brightness with defined edges A count of the number of nanotube materials may then be determined by summing the number of identified nanotube materials.

### Alignment

The image processing algorithm may also be used to determine the alignment of nanotube materials in an image. Nanotube ‘signature’ counts may be performed at a series of ‘angles’ in the pixel matrix. To count a nanotube ‘signature’ at an angle, the image processing algorithm may be programmed to step ‘down’ a set number of vertical pixels ‘Y” for a given number of horizontal pixels ‘+−X’ in the ‘positive’ or ‘negative’ directions from a point within a row. The ArcTangent (Y/X) determines the angle to within the image resolution.

The image processing algorithm may be used to determine an alignment of the nanotube material by analyzing a count of the number of nanotube materials in certain directions. The number of counts may be performed at various angles in search for a minimum count. An efficient way to determine the minimum count is to triangulate by testing, for example, 0, 60, and 120 degrees from the horizontal and then searching between the two minima via half-steps of their difference and so on until the true minimum is found. As can be appreciated by a person skilled in the art, for a perfect alignment of straight long nanotube materials, the count in the aligned direction will be zero.

### Density

The image processing algorithm may also be used to determine the density of nanotube materials in an image. The density of nanotube materials in a given direction may be determined from the count divided by the length traversed. For aligned nanotube materials, the length traversed is the direction perpendicular to the direction of alignment.

### Length

The image processing algorithm may also be used to determine the length of nanotube materials in an image. In one embodiment, if catalyst islands are present, the vertical length distribution of nanotubes in the region being sampled may be determined by analyzing how the number of nanotube materials across a row decreases as one moves away from a catalyst island. If no islands are present, the image processing algorithm may be programmed to analyze a pixel on one row and its neighboring pixels on the next row down to find a continuation of the nanotube ‘signature.’ In this way, nanotube segments may be connected across rows thereby defining a given nanotube material from its starting point to its end point.

### Measuring Individual Nanotubes to Sample for Defects and Alignment

In one embodiment, using the above described information to define a matrix of pixels for a given nanotube, the horizontal movement of the pixels across rows may be used to determine the angle of a segment of the nanotube material. Comparing this angle across segments of the same nanotube allows the ‘straightness’ of the nanotube material to be determined and the severity of any kinks, which may be an indication of defects and diminished nanotube quality/utility. The ‘split’ of a nanotube material into two can be ascertained by pixels representing a single nanotube splitting into two nanotubes with the region around the ‘juncture’ having approximately 50% more nanotube pixels than elsewhere along the nanotube. Similarly a crossing of nanotubes would have twice the nanotube pixels than elsewhere along the nanotube. By performing this on a sampling basis, defect rates, crossings and additional statistics on alignment may be provided and used to correlate with and predict performance for a given application.

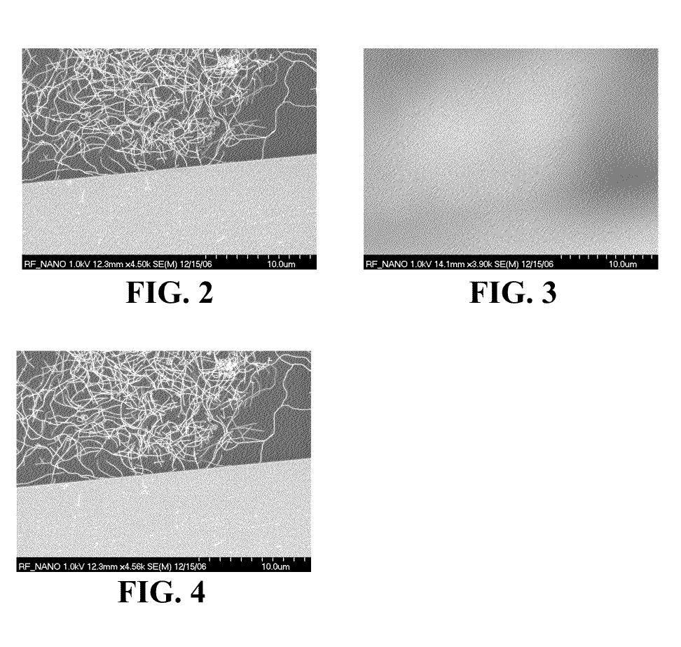

Referring now to FIGS. 2-4, the reliability of the autofocus feature of the SEM is illustrated. FIG. 2 illustrates a sample SEM image of a nanotube material using a manual focus technique by a skilled artisan. In FIG. 3, the image is intentionally blurred in order to test the reliability of the described autofocus feature of the SEM, according to an embodiment of the present disclosure. Referring now to FIG. 4, the autofocus image obtained of the intentionally blurred image of FIG. 3 is shown. As can be seen from the similarity between the manually focused image of FIG. 2 and the autofocused image of FIG. 4, the autofocus feature may be used to achieve similarly focused images for nanotube materials, which may then be analyzed using, for example, an image processing system.

As can be seen from the above, the present disclosure describes a technique that combines SEM control programming, statistical sampling, and image processing algorithms to provide an automated characterization process of nanotube materials, thereby saving considerable time and expense, as well as providing automated cataloguing and reporting of these results. The characterization may include, but is not limited to, determinations of the nanotube material such as count, alignment, density, length. Furthermore, an individual nanotube analysis for identifying defects and alignment statistics may be performed. The automated characterization process may be used to facilitate for the consistent application of nanotubes to devices with reliable performance, which is a fundamental requirement for most products. The results may be used to improve nanotube synthesis recipes and/or ensure quality control in a manufacturing process

While the methods for characterizing nanotube materials have been described in terms of what are presently considered to be the most practical and preferred embodiments, it is to be understood that the disclosure need not be limited to the disclosed embodiments. It should also be understood that a variety of changes may be made without departing from the essence of the invention. Such changes are also implicitly included in the description. They still fall within the scope of this invention. For example, in the present disclosure, a scanning electron microscope (SEM) was used to image the nanotube material. As can be envisioned by a person skilled in the art, any imaging device may be used to image the nanotube material. It should be understood that this disclosure is intended to yield a patent covering numerous aspects of the invention both independently and as an overall system and in both method and machine-readable medium modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action. Similarly, each physical element disclosed should be understood to encompass a disclosure of the action which that physical element facilitates.

It should be understood that various modifications and similar arrangements are included within the spirit and scope of the claims, the scope of which should be accorded the broadest interpretation so as to encompass all such modifications and similar structures. The present disclosure includes any and all embodiments of the following claims.

1. A computer implemented method of characterizing a nanotube material, comprising:
sampling a region of the nanotube material using a scanning electron microscope (SEM) to obtain at least one image; and
analyzing the at least one image using an image processing algorithm to characterize the nanotube material.

2. The computer implemented method of claim 1, wherein the sampling step comprises:
aligning a beam from the scanning electron microscope (SEM) above the region of the nanotube material;
autofocusing the scanning electron microscope (SEM) on the region of the nanotube material; and
capturing at least one image of the region of the nanotube material.

3. The computer implemented method of claim 1, further comprising storing the at least one image in memory.

4. The computer implemented method of claim 1, further comprising generating a score to predict performance of the nanotube material.

5. The computer implemented method of claim 1, wherein the image processing algorithm analyzes the physical characteristics of the nanotube material, the physical characteristics are selected from a group consisting of count, density, length, straightness, alignment and defects.

6. The computer implemented method of claim 1, wherein the image processing algorithm identifies the nanotube material by comparing a neighboring pixel in the at least one image with a predetermined nanotube signature.

7. The computer implemented method of claim 1, wherein the image processing algorithm determines a count of the number of nanotube materials in the at least one image by comparing a pixel row of the at least one image with a predetermined nanotube signature.

8. The computer implemented method of claim 1, wherein the image processing algorithm determines an alignment of the nanotube material by analyzing a count of the number of nanotube materials in different directions.

9. The computer implemented method of claim 1, wherein the image processing algorithm determines a density of the nanotube material by dividing a count of the number of nanotube materials in a certain direction by the length traversed.

10. The computer implemented method of claim 1, wherein the image processing algorithm determines a length of the nanotube material by comparing a pixel row of the at least one image that conforms to a predetermined nanotube signature with at least one neighboring pixel row for accessing the continuity of the nanotube material.

11. A machine-readable medium providing instructions, which when read by a processor, cause the machine to perform operations, comprising:
sampling a region of a nanotube material using a scanning electron microscope (SEM) to obtain at least one image; and
analyzing the at least one image to characterize the nanotube material.

12. The machine-readable medium of claim 11, further comprising instructions for sampling a region of the nanotube material by:
aligning a beam from the scanning electron microscope (SEM) above the region of the nanotube material;
autofocusing the scanning electron microscope (SEM) on the region of the nanotube material; and
capturing at least one image of the region of the nanotube material.

13. The machine-readable medium of claim 11, further comprising instructions for storing the at least one image in memory.

14. The machine-readable medium of claim 11, further comprising instructions for generating a score to predict performance of the nanotube material.

15. The machine-readable medium of claim 11, further comprising instructions for analyzing the physical characteristics of the nanotube material, wherein the physical characteristics are selected from a group consisting of count, density, length, straightness, alignment and defects.

16. The machine-readable medium of claim 11, further comprising instructions for identifying the nanotube material by comparing a neighboring pixel in the at least one image with a predetermined nanotube signature.

17. The machine-readable medium of claim 16, further comprising instructions for determining a count of the number of nanotube materials in the at least one image by summing the identified nanotube material.

18. The machine-readable medium of claim 11, further comprising instructions for determining an alignment of the nanotube material by analyzing a count of the number of nanotube materials in different directions.

19. The machine-readable medium of claim 11, further comprising instructions for:
determining in real time an alignment of the nanotube material from the at least one image;
comparing the alignment to a desired nanotube uniformity; and
ceasing the sampling of the nanotube material when the alignment is within a certain confidence level from the desired nanotube uniformity.

20. An image processing system for characterizing a nanotube material, the system comprising:
an image capturing device for capturing at least one image of a nanotube material;
a memory for storing the at least one image of the nanotube material; and
a processor configured to retrieve the at least one image from the memory and analyze a characteristic of the nanotube material from the at least one image.

21. The image processing system of claim 19, wherein the characteristic of the nanotube material is selected from a group consisting of count, density, length, straightness, alignment and defects.
